(19) United States
(12) Patent Application Publication
(10) Pub. No.: US 2003/0114574 A1
(43) Pub. Date: Jun. 19, 2003

(54) Process for producing thermosetting resin varnish

(75) Inventors: Katsuhiro Furuta, Tsukuba-shi (JP); Yoshiaki Hayashi, Sanda-shi (JP); Toshiaki Hayashi, Tsukuba-shi (JP); Yoshiki Matsuoka, Tsukuba-shi (JP)

Correspondence Address: SUGHRUE MION, PLLC, 2100 Pennsylvania Avenue, NW, Washington, DC, 20037-3213, US

(73) Assignee: SUMITOMO CHEMICAL COMPANY, LIMITED

(21) Appl. No.: 10/288,297

(22) Filed: Nov. 6, 2002

(30) Foreign Application Priority Data
Nov. 12, 2001 (JP) 2001-345927

(51) Int. Cl. C08K 3/34; C08K 3/00

(52) U.S. Cl. 524/492; 524/493; 524/609

(57) ABSTRACT

Provided is a simple process for producing a thermosetting resin varnish comprising a thermosetting resin (A), an aromatic polysulfone resin (B) and an organic solvent (C), wherein a heat processing is conducted at a time of mixing the components (A) and (B) and/or after mixing the components (A) and (B). The varnish has excellent preservation stability.

### BACKGROUND OF THE INVENTION

1. Field of the Invention

The present invention relates to a process for producing a thermosetting resin varnish comprising a thermosetting resin, an aromatic polysulfone resin, and an organic solvent as the indispensable components, wherein heat processing is conducted at a time of mixing and/or after mixing the thermosetting resin and the aromatic polysulfone resin; and also relates to a thermosetting resin varnish obtained by the process.

2. Description of the Related Art

Having mechanically, electrically, and thermally excellent properties, thermosetting resin are broadly used in the fields from daily-necessaries to electric materials and machine materials. Nowadays, with development of advanced technology, thermosetting resins having higher toughness and higher heat resistant property are desired. As a means, proposed are composite materials comprising a super engineering plastic such as polyether sulfone or polysulfone which is a thermoplastic resin and a thermosetting resin. These composite materials have been used in broad fields, such as an airplane use and an electronic material use. Examples used as a printed wired board material for build-up method are described in JP-A-7-33991 and JP-A-7-34048.

When these composite materials are used as a varnish dissolved in an organic solvent, probably because interaction between molecular chains themselves or between the sulfonyl groups and the organic solvent, etc. are caused in an aromatic polysulfone resin. When the temperature falls down, especially in winter, a gel formation occurs, and there has been a problem that heating is necessary to re-dissolve it before using. For this reason, a thermosetting resin varnish having improved preservation stability has been desired.

### SUMMARY OF THE INVENTION

As a result of intensive study in order to solve the above problem, the present inventors found that a thermosetting resin varnish having excellent preservation stability could be manufactured by performing an easy operation of heat processing, at a time of contacting or after contacting a thermosetting resin of component (A) and an aromatic polysulfone resin of component (B), in the process for producing a varnish, and accomplished the present invention.

That is, the present invention provides a process for producing a thermosetting resin varnish comprising a thermosetting resin (A), an aromatic polysulfone resin (B), and an organic solvent (C), wherein heat processing is conducted at a time of mixing the components (A) and (B) and/or after mixing the components (A) and (B).

### DETAILED DESCRIPTION OF THE INVENTION

As the thermosetting resin of component (A) in the present invention, known materials such as a urea resin, a melamine resin, a phenol resin, a unsaturated polyester resin, an acrylate resin, and an epoxy resin are exemplified. Among them, an epoxy resin is preferably used in view of performance balance, such as heat resistance and water absorption.

As the epoxy resins, exemplified are: bifunctional epoxy resin derived from divalent phenol, such as bisphenol A, bisphenol F, tetrabromo bisphenol A, bisphenol S, dihydroxy biphenyl, dihydroxy naphthalene, dihydroxy stilbene, and alkyl substitution hydroquinone; novolak type epoxy resin such as phenol novolak, cresol novolak and bisphenol A novolak; polyfunctional epoxy resin derived from polycondensation products of a phenol, such as phenol, alkyl substitution phenol and naphthol with an aldehyde, such as benzaldehyde, hydroxy benzaldehyde and alkyl substitution terephthalaldehyde; and epoxy resin derived from polyaddition product of phuenol and cyclopentadiene. Two or more of these can also be used, according to requirements.

Among the above epoxy resins, in view of reactivity, compatibility with a wholly aromatic polysulfone resin, heat resistance and low water absorptivity, etc., of the cured product, preferable are an epoxy resin derived from bisphenol A, an epoxy resin derived from bisphenol F, an epoxy resin derived from phenol novolak, an epoxy resin derived from cresol novolak, a polyfunctional epoxy resin; more preferable is a polyfunctional epoxy resin; and further preferable is a polyfunctional epoxy resin represented by the following formula (1).

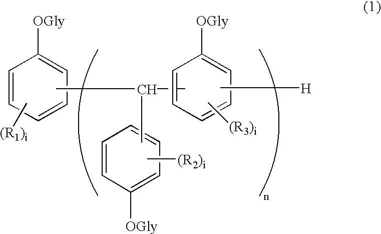

wherein, n represents an average repeating number and represents 1 to 10; R₁, R₂, and R₃ each independently represent an alkyl group having 1 to 10 carbon atoms, a cycloalkyl group having 5 to 7 carbon atoms, or a hydrocarbon group having 6 to 20 carbon atoms which contain a cycloalkyl group having 5 to 7 carbon atoms; i each independently represents an integer of 0 to 4; when i is two or more, a plurality of R₁, R₂ and R₃ may be mutually the same or different; and Gly represents glycidyl group.

As the examples of the alkyl group having 1 to 10 carbon atoms in R₁, R₂, and R₃, exemplified are methyl, ethyl, n-propyl, i-propyl, n-butyl, i-butyl, sec-butyl, t-butyl, pentyl, hexyl, heptyl, etc. As the examples of the cycloalkyl group having 5 to 7 carbon atoms, exemplified are cyclopentyl, cyclohexyl, cycloheptyl, etc. As the examples of the hydrocarbon group having 6 to 20 carbon atoms containing a cycloalkyl group having 5 to 7 carbon atoms, exemplified are cyclopentylmethyl, cyclohexylmethyl, cyclohexylethyl, etc.

Among the above, R₁, R₂, and R₃ are preferably a group selected from methyl, ethyl, and t-buty, each independently. Preferably, n is 1 to 5, and i is 0 to 3, and more preferably n is 1 to 3, and i is 0 to 2. As the specific example of the polyfunctional epoxy resin represented by general formula (1), TMH-574 (trade name) produced by Sumitomo Chemical Co., Ltd., etc. are exemplified.

The amount of thermosetting resin used as component (A), such as an epoxy resin, can be suitably determined according to the relation with other components, and it is usually 10% by weight or more and 90% by weight or less, based on the total amount of resins (thermosetting resin (A) and aromatic polysulfone resin (B)), and preferably 20% by weight or less and 80% by weight or more.

Furthermore, when using an epoxy resin as component (A), it can be used together with an epoxy resin curing agent. As such a curing agent, exemplified are: polyhydric-phenol type curing agents, such as phenol novolak, cresol novolak, tris (hydroxy phenyl) alkanes, phenol modified polybutadiene, phenol aralkyl resin, and polyaddition product of phenol and dicyclopentadiene; amine type curing agents, such as dicyandiamide, diaminodiphenylmethane, and diaminodiphenylsulfone; and acid-anhydride type curing agents, such as pyromellitic anhydride, trimellitic anhydride, and benzophenone tetracarboxylic acid di-anhydride, etc. Known curing agents can be used, and two or more of them can also be used together according to requirements.

Among them, from the viewpoint of low water absorptivity of the cured product, polyhydric-phenol type curing agent is preferable, and phenol novolak is especially preferable.

Moreover, a phenol novolak resin in which a phenolic raw material is modified with a compound having triazine structures, such as melamine, benzoguanamine, etc. is also preferable.

By changing the kind, using amount, etc. of the curing agent, the glass transition temperature of the cured product obtained from the thermosetting resin varnish of the present invention can be changed. When a cured product having a high glass transition temperature is desired, an epoxy resin may be used as the thermosetting resin and a phenol novolak may be used as the curing agent. The epoxy equivalent of the epoxy resin and the hydroxyl equivalent of the epoxy resin curing agent may be set to 1:0.8 to 1:1.2, preferably 1:1.

Moreover, a catalyst can be added to the thermosetting resin varnish in order to promote the curing reaction. For example, when an epoxy resin is used as a thermosetting resin, examples of the curing catalyst include: organic phosphine compounds, such as triphenyl phosphine, tri-4-methyl phosphine, tri-4-methoxy phenyl phosphine, tributyl phosphine, trioctyl phosphine, and tri-2-cyanoethyl phosphine, and tetraphenyl-borate salts thereof; tertiary amines, such as tributyl amine, triethyl amine, 1,8-diazabicyclo (5,4,0) undecene-7, and triamyl amine; quarternary ammonium salts, such as benzylchloride trimethyl ammonium, hydroxybenzyl trimethyl ammonium, and triethyl ammonium tetraphenyl borate; and imidazoles, such as 2-ethyl imidazole and 2-ethyl-4-methyl imidazole. Known curing catalysts can also be used. Moreover, among them, organic phosphine compound and imidazole are more preferable. The curing catalyst is added in an appropriate amount so that a desired gel time may be obtained. It is preferable to use a curing agent so that the gel time of the composition is from 1 minute to 15 minutes at a previously determined temperature of between 80 and 250° C.

The thermosetting resin varnish of the present invention comprises an aromatic polysulfone resin which is a component (B), and an organic solvent which is component (C), as the indispensable components, besides the thermosetting resin which are the above components (A). As the aromatic polysulfone resin (B), known resins, such as polysulfone and polyether sulfone, can be exemplified. Among them, since the cured product can be toughened effectively, a polyether sulfone is preferable.

Here, as the aromatic polysulfone resin, for example, those having an end group, such as chlorine atom, alkoxy group and a phenolic hydroxyl group, are known. In view of solvent resistance and toughness of the cured product, phenolic hydroxyl group is preferable. In this case, it is more preferable that both terminals are phenolic hydroxyl groups. Furthermore, weight average molecular weight of the aromatic polysulfone resin is preferably 1000 to 100000. When it is 1000 or less, toughness may become insufficient, and brittleness may tend to appear. Moreover, when it is more than 100000, it is difficult to dissolve in a solvent and is easy to form gel.

The amount of the aromatic polysulfone resin is preferably 10% by weight to 50% by weight based on the total amount of resins including a resin used as a curing agent. When it is less than 10% by weight, toughness of the cured product may fall. When it exceeds 50% by weight, processability of the composition may fall, and further, water absorption of the cured product may increase.

The aromatic polysulfone resins can be obtained according to well known methods. Commercial products can also be used, for example, SUMIKAEXCEL (trade name, having below structure (A), produced by Sumitomo Chemical Co., Ltd.); REDEL (trade name, having below structure (B), produced by Amoco Corporation); UDELP-1700 (trade name, having below structure (A), produced by Amoco Corporation); and Ultrason (trade name, having below structure (A), produced by BASF Co.).

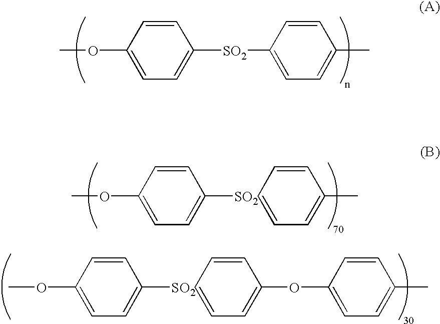

At a time of varnish manufacture, the aromatic polysulfone resin can be used as a solid form such as powder or pellet, but it is preferable to use with dissolving it in a solvent beforehand for varnish production. Since the aromatic polysulfone resin in solid form is generally hard to dissolve in a solvent, use of a solution thereof is advantageous in varnish production.

Furthermore, the organic solvent (C) of the present invention can be selected from well known solvents dissolving especially an aromatic polysulfone resin. For example, acetone, methylethyl ketone (MEK), toluene, xylene, n-hexane, methanol, ethanol, methyl cellosolve, ethyl cellosolve, cyclohexanone, N,N-dimethyl acetamide, methylisobutyl ketone (MIBK), 4-butyrolactone, dimethylformamide (DMF), N-methyl-2-pyrrolidone (NMP), dimethyl sulfoxide or the mixtures thereof can be used. Especially, organic solvents consisting of at least one of N-methyl-2-pyrrolidone, 4-butyrolactone, N,N-dimethyl acetamide, dimethyl sulfoxide, methylethyl ketone, toluene, and xylene is preferable.

The organic solvent is usually used in an amount of about 0.5 to 12 times in weight based on the total amount of resins.

The thermosetting resin varnish in the present invention comprises, as the indispensable components, a thermosetting resin (A), an aromatic polysulfone resin (B), and an organic solvent (C). And further, an inorganic filler (D) can also be contained, according to requirements. As such an inorganic filler, silica, titanium oxide, alumina, etc. are exemplified, and two or more kinds of these can be also used. Especially silica is preferably used since the dielectric constant is low and the coefficient of linear expansion is low.

When an inorganic filler is used, the amount is usually 5 to 40% by weight based on the total amount of resins. Moreover, the mean particle diameter of the filler is preferably 0.1 μm or more. When it is less than 0.1 μm, fillers will become easy to aggregate, the viscosity of the varnish will increase to make the workability inferior.

Usually, the inorganic filler is used as being dispersed in an organic solvent etc. using a dispersion apparatus. As the dispersion apparatus, well known apparatus such as a bead mill, a ball mill, a sand mill, and a roll mill can be used. Among them, it is preferable to use a bead mill. Here, as a dispersion media in dispersion process, glass beads and zirconia beads can be used. Steel balls and stainless-steel balls can also be used, but it is better to use glass beads and zirconia beads for an electronic material use, since contamination of Fe component in the varnish could happen.

In the present invention, an inorganic filler which is surface-treated by adding a coupling agent to a mill base where the inorganic filler is dispersed in an organic solvent etc., can also be used.

The thermosetting resin varnish is manufactured by mixing the above components. It is important to perform heat processing of the thermosetting resin of component (A) and the aromatic polysulfone resin of component (B) at the time of contacting or after contacting the both. It is important that the heat processing is carried out in a state where the both components exist, such as, at the time of mixing or after mixing the both components. By this, the preservation stability of the thermosetting resin varnish can be remarkably improved.

Heat processing temperature of the solution is suitably 50° C. to 90° C., and more suitably 60° C. to 80° C. When it is 50° C. or less, improvement effect of preservation stability tends to fall, and when it is 90° C. or more, volatilization of the solvent and advance of the material may occur, thus it is not preferable.

Heat processing time is suitably 30 to 180 minutes, and more suitably 45 to 120 minutes. When it is less than 30 minutes, improvement effect of preservation stability tends to fall, and when it is more than 180 minutes, volatilization of the solvent and advance of the material may occur, thus it is not preferable.

### EXAMPLES

Hereafter, although the examples explain the present invention still in detail, the present invention is not limited only to the examples.

The structures of the compounds used in Examples are as follows.

PSM4261(Phenol novolak)

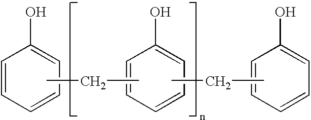

YD-128M (bisphenol A type epoxy resin)

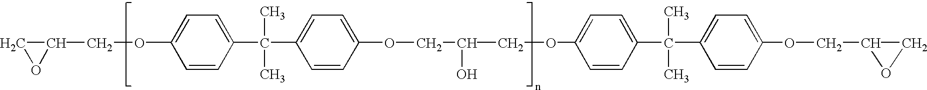

TMH-574 (polyfunctional epoxy resin) n=1

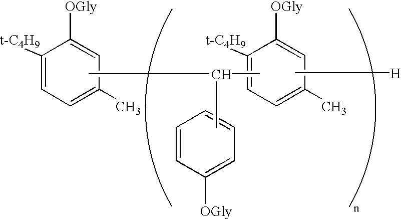

SUMIKAEXCEL 5003 P (polyether sulfone having terminal hydroxyl group) n=100

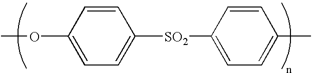

### Example 1

Phenol novolak (PSM4261 (trade name), produced by Arakawa Chemical Industries, Ltd.) 39.47 g was dissolved in a mixed solvent 92.31 g of 4-butyrolactone and N-methyl-2-pyrrolidone. To this solution, silica filler (1-FX (trade name), mean particle diameter of 0.2 μm, produced by Tatsumori, Ltd.) 68.22 g was mixed, and dispersed for 30 minutes by a bead mill with using 200 g of glass beads as a media. After removing the glass beads away, silane coupling agent (KBM-403 (trade name) produced by Shin-Etsu Chemical Co., Ltd.) 0 83 g was added to this dispersed solution 80.59 g, and stirred for 30 minutes by a high speed impeller mixer. To this, at 25° C., a solution of bisphenol A type epoxy resin (YD-128M (trade name) produced by Tohto Kasei Co., Ltd.) 3.21 g and polyfunctional epoxy resin (TMH-574 (trade name) produced by Sumitomo Chemical Co., Ltd.) 28.99 g, and terminal hydroxyl group modified polyether sulfone (SUMIKAEXCEL 5003 P (trade name) produced by Sumitomo Chemical Co., Ltd.) in a mixed solvent (24.5 weight %, 49.41 g) of 4-butyrolactone/N-methyl-2-pyrrolidone (4/1 in weight) was added, and stirred for 30 minutes. Then, in a state of uniform solution, the varnish was heated to 55° C., and stirred for 1 hour. Furthermore, 50.82 g of a mixed-solvent having the same composition as above and 0.13 g of triphenyl phosphine were added, and stirred for 30 minutes to obtain a varnish.

The preservation stability test of the obtained varnish was performed by keeping it at 25° C. The confirmation of gel formation was performed visually. After 3 weeks, the varnish has still fluidity, and gel formation was not observed.

### Comparative example 1

A varnish was obtained as the same manner with Example 1 except that the heat processing of stirring at 55° C. for 1 hour after polyether sulfone formulation was not performed, but stirred at 25° C. for 1 hour. The same preservation stability test as Example 1 was performed. The gel formation was observed after seven days.

### Example 2

Polyfunctional epoxy resin (TMH-574 (trade name) produced by Sumitomo Chemical Co., Ltd.) 30.82 kg was dissolved in a mixed solvent 28.69 kg of 4-butyrolactone/N-methyl-2-pyrrolidone (4/1 in weight). To this solution, silica filler (1-FX (trade name), produced by Tatsumori, Ltd.) 19.00 kg was mixed, and dispersed by Dyno Mill (MCM-PILOT, produced by Shinmaru Enterprises, Inc.). To the resultant solution 60.69 kg, silane coupling agent (KBM-403 (trade name) produced by Shin-Etsu Chemical Co., Ltd.) 0 436 kg was added, and stirred for 60 minutes by a high speed impeller mixer. After surface-treatment of silica, to this solution 55.98 kg, at 30° C., a solution of bisphenol A type epoxy resin (YD-128M (trade name) produced by Tohto Kasei Co., Ltd.) 5.39 kg and terminal hydroxyl group modified polyether sulfone (SUMIKAEXCEL 5003 P (trade name) produced by Sumitomo Chemical Co., Ltd.) in a mixed solvent (23.2 weight %, 68.83 kg) of 4-butyrolactone/N-methyl-2-pyrrolidone (4/1 in weight) was added, and stirred for dissolution. At this polyether sulfone formulation stage, varnish liquid temperature was raised to 60° C., and stirred at 60° C. for 1 hour, then the heat processing was stopped. Then, melamine modified phenol novolak (KA-7052-L2 (trade name) produced by Dainippon Ink) 10.27 kg was added, stirred and dissolved. To this solution, a mixed-solvent 11.48 kg was added and stirred for 30 minutes. Furthermore, 2-ethyl-4-methyl imidazole 53.2 g as a curing catalyst and methylethyl ketone 3.09 kg were added, and stirred for 30 minutes, and a varnish was obtained.

The same preservation stability test as Example 1 was performed. After 1 month, the gel formation was not observed.

### Comparative Example 2

A varnish was obtained as the same manner with Example 2 except that the heat processing of stirring at 60° C. for 1 hour after polyether sulfone formulation was not performed, but stirred at 30° C. for 1 hour. The same preservation stability test as Example 1 was performed. The gel formation was observed after four days.

TABLE 1
Result of Preservation Stability Test

| Example | Gel formation Time |
|---|---|
| Example 1 | 3 weeks or more |
| Comparative Example 1 | 7 days |
| Example 2 | 1 month or more |
| Comparative Example 2 | 4 days |

According to the present invention, the preservation stability of a thermosetting resin varnish may be improved by performing a simple operation of heat processing at a time of mixing and/or after mixing a thermosetting resin (A) and an aromatic polysulfone resin (B).

What is claimed is:

1. A process for producing a thermosetting resin varnish comprising a thermosetting resin (A), an aromatic polysulfone resin (B), and an organic solvent (C) as indispensable components, wherein heat processing is conducted at a time of mixing the components (A) and (B) and/or after mixing the components (A) and (B).

2. A process according to claim 1, wherein the thermosetting resin varnish further contains inorganic filler (D).

3. A process according to claim 1 or 2, wherein component (A) consists of an epoxy resin.

4. A process according to claim 3, wherein the epoxy resin is an epoxy resin represented by following structural formula (1), 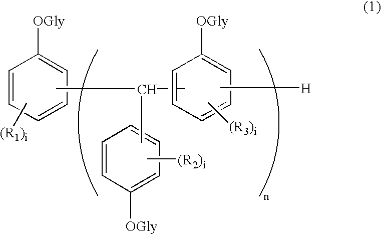
wherein, n represents an average repeating number and represents 1 to 10; R₁, R₂, and R₃ each independently represent an alkyl group having 1 to 10 carbon atoms, a cycloalkyl group having 5 to 7 carbon atoms, or a hydrocarbon group having 6 to 20 carbon atoms which contain a cycloalkyl group having 5 to 7 carbon atoms; i each independently represents an integer of 0 to 4; when i is two or more, a plurality of R₁, R₂ and R₃ may be mutually the same or different; and Gly represents glycidyl group.

5. A process according to claim 1 or 2, wherein component (B) is a polyether sulfone.

6. A process according to claim 1 or 5, wherein component (B) has a phenolic hydroxyl group as the end group.

7. A process according to claim 1, wherein component (C) contains at least one selected from acetone, methylethyl ketone, toluene, xylene, n-hexane, methanol, ethanol, methyl cellosolve, ethyl cellosolve, cyclohexanone, N,N-dimethyl acetamide, methylisobutyl ketone, 4-butyrolactone, dimethylformamide, N-methyl-2-pyrrolidone and dimethyl sulfoxide.

8. A process according to claim 2, wherein component (D) has a mean particle diameter of 0.1 to 3 μm.

9. A process according to claim 2 or 8, wherein component (D) is silica.

10. A process according to claim 1 or 2, wherein the heat processing is conducted at a temperature of 50 to 90° C.

11. A thermosetting resin varnish obtained by a process according to claim 1 or 2.

12. A cured product obtained by curing the thermosetting resin varnish according to claim 11.
